(19) United States
(12) Patent Application Publication
(10) Pub. No.: US 2007/0181267 A1
(43) Pub. Date: Aug. 9, 2007

(54) Sectional door panel

(75) Inventor: Willis J. Mullet, Gulf Breeze, FL (US)

Correspondence Address: Phillip L. Kenner;Renner, Kenner, Greive, Bobak, Taylor & Weber, Fourth Floor, First National Tower, Akron, OH, 44308-1456, US

(73) Assignee: Wayne-Dalton Corporation

(21) Appl. No.: 11/346,747

(22) Filed: Feb. 4, 2006

(51) Int. Cl. E05D 15/00

(52) U.S. Cl. 160/201

(57) ABSTRACT

A sectional door movable between a closed vertical position and an open horizontal position having, a plurality of adjacent panels joined by hinges for articulation in moving between the closed vertical position and the open horizontal position, each of the panels having a facer defining the perimeter of the panels by longitudinal edge extensions terminating in ends, the hinges and the longitudinal edge extensions configured to maintain a clearance between the longitudinal edge extensions of the adjacent panels during articulation thereof, and an up-bow in the longitudinal edge extensions to prevent sagging that could result in interference between longitudinal edge extensions of the adjacent panels when the panels are substantially in the horizontal position.

### TECHNICAL FIELD

The present invention generally relates to the panels of a sectional door used in a sectional door system. More particularly, the present invention relates to the panels of a sectional door being specially configured to inhibit contact between adjacent panels during opening and closing movements thereof. More specifically, the present invention relates to the panels being configured to effectively reinforce the pinch resistant interfaces provided between adjacent panels, and maintain relatively constant gaps therebetween during opening and closing movement of the sectional door. Still more specifically, the present invention relates to the panels of a sectional door being contoured such that the centers thereof are bowed outwardly to effectively reinforce the panels without adding additional weight.

### BACKGROUND ART

Conventional sectional doors used in sectional door systems are typically composed of panels configured to provide pinch resistant panel to panel interfaces. To avoid pinching a user's hands or fingers during opening and closing movements of the sectional door, the panels are configured to provide for relatively constant gaps between adjacent panels that are small enough to prohibit hands or fingers from being inserted therein.

Typically, the pinch resistant panel to panel interfaces are formed using complimentary structures along the interfaces of adjacent panels. The complimentary structures mate with one another, and maintain the gaps between adjacent panels within specified tolerances during articulation of the panels between the open and closed positions. Provided that the specified tolerances of the gaps are small enough, insertion of a user's hand or fingers between adjacent panels can be precluded.

When conventional sectional doors are disposed in the open, horizontal position, however, the center portions of the panels tend to hang lower than the remainder thereof. Such sagging causes deflection of the panels, and can adversely effect the efficient operation of the sectional door by causing interference between adjacent panels. To illustrate, when the sectional door is being closed, the panels pass through the curved transition track sections between the vertical track sections and horizontal track sections. In doing so, a horizontally disposed panel approaches its maximum deflection while an adjacent panel in the transitional track section is undergoing a substantially lesser deflection. The varying amounts of deflection experienced by these adjacent panels can cause the edges of these adjacent panels to rub against one another during opening and closing movements.

Interference between adjacent panels can cause weather seals placed along the panel to panel interfaces to deteriorate rapidly, and, in extreme circumstances, can cause adjacent panels to bind against one another, thereby inhibiting opening and closing movement. Moreover, because the forces introduced by binding are not linear, a surging condition can be generated during opening and closing movements of the sectional door. If motorized operators are used, the surging condition can interfere with proper operation of control systems used to respond to forces generated by entrapment. That is, because the control systems may recognize the surging condition as force variations generated by entrapment, the surging condition may interfere with the proper operation of the motorized operators.

Interference between adjacent panels due to deflection caused by sagging is exacerbated when the sectional doors include pinch resistant panel to panel interfaces. Because adjacent panels of sectional doors having pinch resistant panel to panel interfaces must articulate within close proximity to one another, deflection more readily causes interference. Moreover, reinforcing the panels along the panel to panel interfaces to reduce deflection caused by sagging adds weight. Although such reinforcement is successful to some extent, additional weight eventually leads to additional sagging. Consequently, there is a need for the panels of a sectional door to be specially configured to inhibit contact between adjacent panels during opening and closing movements thereof. Such panels should be configured to resist deflection, thereby limiting interference therebetween during opening and closing movements of the sectional door without adding additional weight, complexity or cost to the panels.

### DISCLOSURE OF THE INVENTION

Therefore, an object of the present invention is to provide panels for a sectional door that are configured to inhibit contact between adjacent panels during opening and closing movements thereof. Another object of the present invention is to maintain relatively constant gaps between adjacent panels during opening and closing movement of the sectional door. Yet another object of the present invention is to contour individual panels so that the longitudinal centers thereof are bowed outwardly to effectively reinforce the panels without adding additional weight.

Another object of the present invention is to provide a panel configuration that prevents damage to weather seals located in the interfaces between panels and otherwise extends the service life of such weather seals. A further object of the invention is to provide such a panel configuration that maintains sufficient uniformity in the gap between panels, so as to eliminate the need for “rub-strips” between adjacent panels.

A further object of the present invention is to provide a panel configuration that does not require additional reinforcement, such as struts, cables, rods, turnbuckles and the like to prevent deflection both in the vertical and horizontal positions of the door. Still another object of the invention is to provide such a panel configuration that allows greater manufacturing tolerances in the panel interfaces due to the out-bow compensating therefor. Yet another object of the invention is to provide such a panel that may be made of lighter gauge steel or thinner facer material to reduce cost while maintaining sufficient strength and rigidity to meet operating parameters of the sectional door.

In general, the present invention contemplates a sectional door movable between a closed vertical position and an open horizontal position having, a plurality of adjacent panels joined by hinges for articulation in moving between the closed vertical position and the open horizontal position, each of the panels having a facer defining the perimeter of the panels by longitudinal edge extensions terminating in ends, the hinges and the longitudinal edge extensions configured to maintain a clearance between the longitudinal edge extensions of the adjacent panels during articulation thereof, and an up-bow in the longitudinal edge extensions to prevent sagging that could result in interference between longitudinal edge extensions of the adjacent panels when the panels are substantially in the horizontal position.

### BRIEF DESCRIPTION OF THE DRAWINGS

FIG. 1 is a rear perspective view of a door system including a sectional door formed from a plurality of sectional door panels configured according to the concepts of the present invention.

FIG. 1A is an enlarged perspective view of a door panel, which is exemplary of any one of the plurality of door panels depicted in FIG. 1, showing an extent of bowing of the panel by a plane tangent to the middle of the outer surface of the panel when disposed in a vertical position.

FIG. 2 is an enlarged side elevational view of the sectional door panel as viewed substantially at line 2-2 of FIG. 1A.

FIG. 3 is a top plan view of the sectional door panel depicted in FIG. 1A showing details of the bowing of the panel with the middle of the panel deflected a distance X relative to the end of the panel when the panel is in a vertical orientation with the door in the closed position.

### BEST MODE FOR CARRYING OUT THE INVENTION

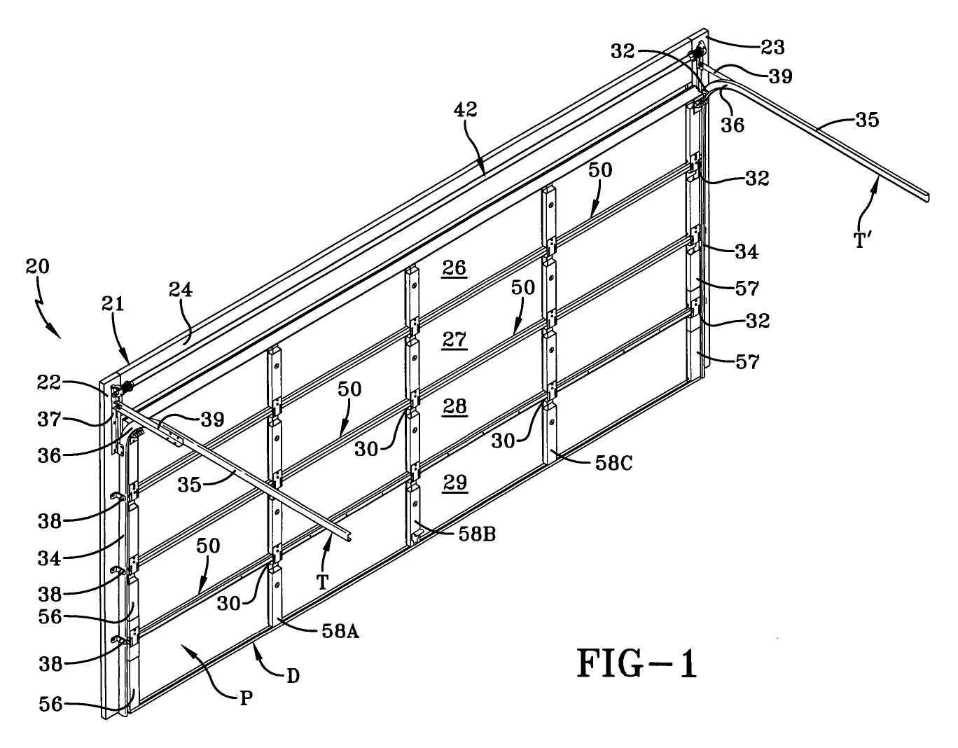

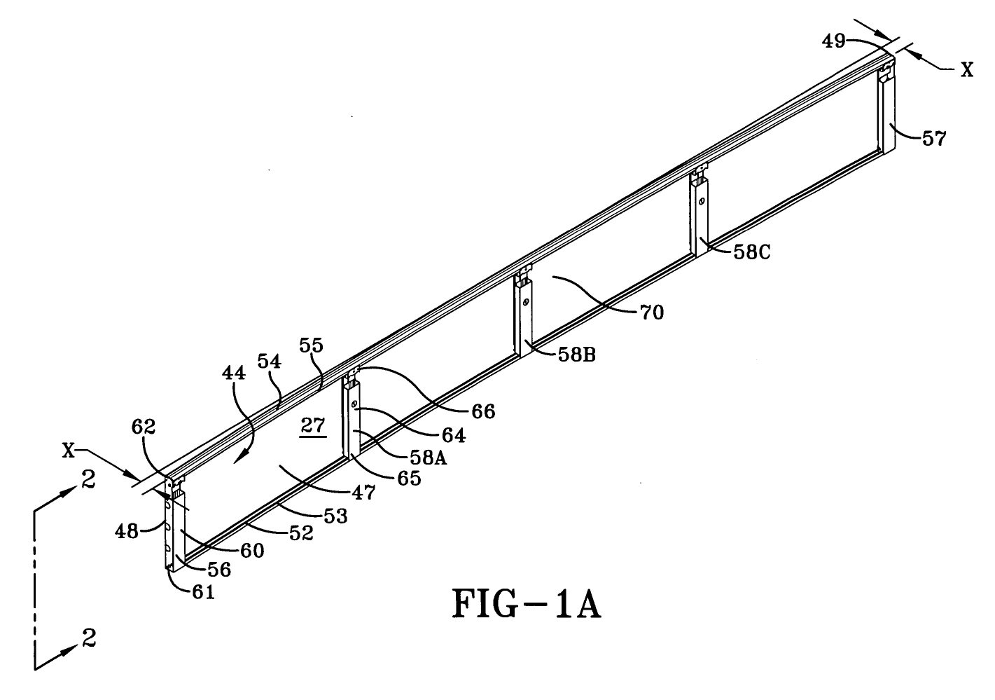

The upward acting insulated or uninsulated sectional door system embodying the concepts present invention is generally indicated by the 20 in FIG. 1 of the accompanying drawings. The sectional door system 20 employs a sectional door, generally indicated at D, which is positioned for opening and closing movements relative to an opening defined by a frame, generally indicated by the numeral 21. The frame 21 includes a pair of spaced jambs 22 and 23 joined adjacent their vertical upper extremities by a header 24. The frame 21 delineates a generally inverted U-shaped reinforcement around the opening for door D. As persons skilled in the art will appreciate, the frame 21 is normally constructed of lumber for purposes of reinforcement, and to facilitate the attachment of elements supporting the sectional door D.

As seen in FIG. 1, the sectional door D includes a rectangular arrangement of panels, individually referred to by the character P. As shown, the panels P constituting door D include an upper panel 26, an upper intermediate panel 27, a lower intermediate panel 28, and a lower panel 29. However, it will be appreciated that more or less panels may be employed in sectional doors of this type depending upon the height and width of the door opening, and related considerations.

To permit the requisite opening and closing movement of the sectional door D, the panels P are hingedly interconnected using hinge mechanisms 30. Furthermore, the panels P are movably interrelated with the opening defined by the frame 21 using a track system including tracks T positioned on one side of the opening and tracks T′ positioned on the other side of the opening. To facilitate such movement, the tracks T and T′ are configured to receive a plurality of rollers 32 that are attached at various positions along the vertical ends of each of the panels P. Moreover, to define the path of movement of the panels P, the tracks T and T′ each include vertical track sections 34, horizontal track sections 35, and transitional track sections 36 together the vertical track sections 34 and the horizontal track sections 35. As such, to facilitate opening and closing movement of the sectional door D along the tracks T and T′, the rollers 32 allow the panels P to move along the path defined by the tracks T and T′, and the hinge mechanisms 30 allow the panels P to articulate with respect to one another, as necessary to maintain a minimum clearance while restricting the gap between panels to meet industry pinch resistant specifications.

The tracks T and T′ are supported relative to the frame 21 by flag angles 37, angle brackets 38, horizontal angles 39, and struts (not shown). The struts hang down from the overhead (not shown) preferably proximate the rear end of the horizontal track sections 35, and the angle brackets 38 are attached to the jambs 22 and 23 to support the vertical track sections 34. The flag angles are attached to the jambs 22 and 23 and the horizontal angles 39 are attached to the flag angles 37 to support the transitional track sections 36, and also the horizontal track sections 35.

The flag angles 37 can also be used to mount a counterbalance system, generally indicated by the numeral 42 in FIG. 1. The counterbalance system 42 interacts with the sectional door D to facilitate opening and closing movements thereof in a manner well-known to person skilled in the art. While a counterbalance system according to Applicant's U.S. Pat. No. 5,419,010 is shown for exemplary purposes in FIG. 1, it will be appreciated by those skilled in the art that any of a variety of counterbalancing systems known in the art may be employed.

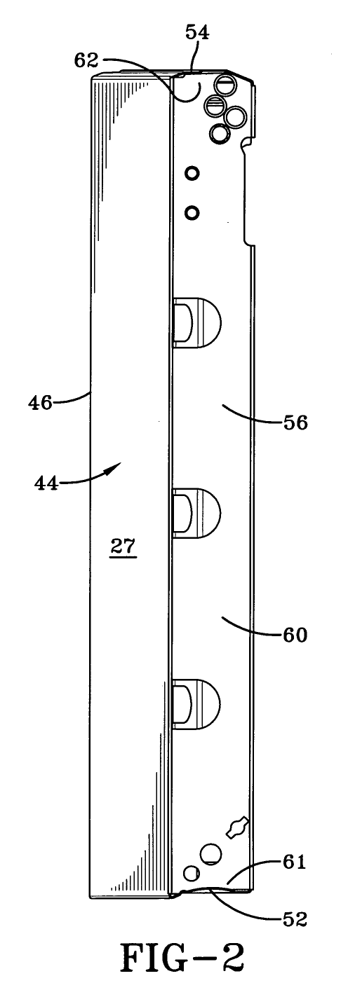

As shown in FIG. 1, each of the panels P has as a primary structural member a facer, generally indicated by the numeral 44. The facer 44 has a front surface 46 (FIG. 2) and a back surface 47 (FIG. 1A), and extends over the height and width of each of the panels P. The panel facers 44 each include a left-hand vertical end 48, a right-hand vertical end 49, and joint assemblies, generally indicated by the numeral 50, extending rearwardly from the facer 44 along the upper and lower extremities thereof. The joint assemblies 50 include generally concave edge extensions 52 and upturned lips 53 extending upwardly therefrom along the lower extremities of the panels P, and generally convex edge extensions 54 and downturned lips 55 extending downwardly therefrom along the upper extremities of the panels P. The concave edge extension 52, convex edge extension 54, left-hand vertical end 48 and right-hand vertical end 49 define the perimeter of each of the panels P.

To enhance the rigidity of sectional door D, various vertical support members, such as stiles, may be used in connection with each of the panels P. For example, each of the panels P may include a left-hand end stile 56 provided along the left-hand vertical end 48, and right-hand end stile 57 provided along the right-hand vertical end 49. If necessary or desirable, one or more center stiles may be located between the left-hand and right-hand vertical edges 48, 49 of each of the panels P. For example, as shown in FIG. 1, three (3) center stiles, a first center stile 58A, a second center stile 58B, and a third center stile 58C, are provided between the left-hand end stile 56 and right-hand end stile 57 on the panels P.

The left-hand end stile 56, right hand end stile 57, and center stiles 58A, 58B, and 58C are generally elongate members that extend between the concave edge extensions 52 and convex edge extensions 54. As such, the left-hand end stiles 56, right hand and stiles 57, and center stiles 58 are adapted to fit within the confines of the panels P, and may be attached to the back surface 47 using adhesives and/or mechanical fasteners.

The left-hand end stiles 56 and right-hand end stiles 57 generally include stile bodies 60, which may be hollow and have a rectangular cross-sectional shape. The stile bodies 60 may be contoured at their bottoms 61 and tops 62 to substantially conform to the concave edge extensions 52 and convex edge extensions 54, respectively, and provide additional support thereto. The center stiles 58 may also generally include stile bodies 64 somewhat similar to the stile bodies 60. The stile bodies 64 may also be contoured at their bottoms 65 and tops 66 to substantially conform to the concave edge extensions 52 and convex edge extensions 54, respectively.

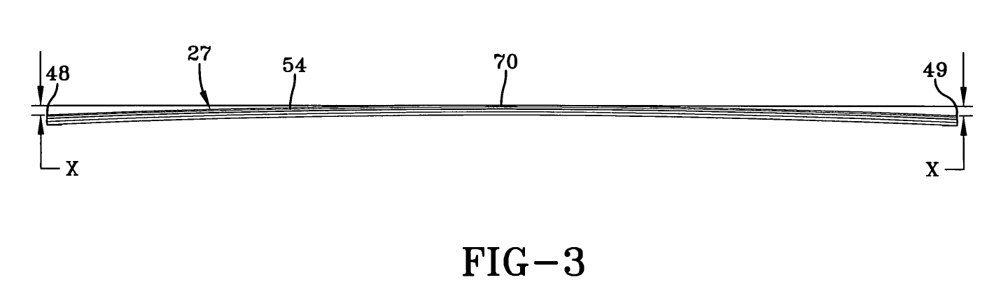

Each of the panels P has generally the same configuration, and, therefore, for exemplary purposes, only the upper intermediate panel 27, as depicted in FIGS. 1A, 2, and 3, is hereinafter discussed in detail. As shown in FIGS. 1A and 3, the intermediate panel 27 has an outwardly contoured shape so that its center 70 is bowed outwardly from its left-hand vertical end 48 and right-hand vertical end 49 by a distance X. When the sectional door D is in the open, horizontal position, the intermediate panel 27 is curved upwardly, and, is accordingly referred to as being “up-bowed”, or alternatively as “out-bowed.”

The outwardly contoured shape of the intermediate panel 27 resists sagging when the sectional door D is in the open, horizontal position. That is, the outwardly contoured shape medially of the intermediate panel 27 provides reinforcement which counters the forces of gravity to inhibit and/or compensate for sagging or distortion. As such, the outwardly contoured shape adds rigidity to the intermediate panel 27 to reduce deflection along its upper and lower extremities, the concave edge extension 52 and convex edge extension 54, respectively, particularly when a panel P reposes in horizontal track sections 35 or transitional track sections 36.

The outwardly contoured shape of the intermediate panel 27 is formed during the production process, and can be imparted to the intermediate panel 27 using a variety of manufacturing techniques including roll forming and/or stamping processes. As shown in FIGS. 1A and 3, the degree of the outwardly contoured shape of the intermediate panel 27 is directly related to the distance X. The distance X is a measurement of the deflection between a plane tangential to the center 70 and the left-hand vertical end 48 and the right-hand vertical end 49 of the intermediate panel 27 in a plane perpendicular to the plane tangential to the center 70. The distance X can be varied during the production process to provide the intermediate panel 27 with a predetermined, selected outwardly contoured shape. For example, the distance X can be selectively increased or decreased to accommodate varying lengths of the intermediate panel 27, facer material and thickness and numerous other design variables.

It has been empirically determined that having the distance X proportional to about 1/480 of the length of the intermediate panel 27 serves to resist sagging without otherwise effecting operation of the sectional door system 20 with the panel configuration depicted herein and employing as the panel material a relatively thin sheet steel as is known in the art. In the instance of a sixteen (16) foot panel 27, the distance X would thus be approximately 0.4 inch. As such, depending on the length of the intermediate panel 27, the distance X will be varied to increase the rigidity of the intermediate panel 27, and inhibit sagging thereof. In doing so, deflection of the intermediate panel 27 due to sagging is reduced, and interference between adjacent panels during opening and closing movement of the sectional door D is limited without adding additional weight to the panels. It will be appreciated that variations in panel configurations and material thickness and constitution could result in an optimum distance X ranging from approximately 1/312 to 1/636 of the width of a panel or greater. In some instances depending upon the construction of the panel joint assemblies 50, the extent of up-bow may be varied between the top and bottom edges of the panels.

Thus, it should be evident that the sectional door panel disclosed herein carries out one or more of the objects of the present invention set forth above and otherwise constitutes an advantageous contribution to the art. As will be apparent to persons skilled in the art, modifications can be made to the preferred embodiment disclosed herein without departing from the spirit of the invention, the scope of the invention herein being limited solely by the scope of the attached claims.

1. A sectional door movable between a closed vertical position and an open horizontal position comprising, a plurality of adjacent panels joined by hinges for articulation in moving between the closed vertical position and the open horizontal position, each of said panels having a facer defining the perimeter of said panels by longitudinal edge extensions terminating in ends, said hinges and said longitudinal edge extensions configured to maintain a clearance between said longitudinal edge extensions of said adjacent panels during articulation thereof, and an up-bow in said longitudinal edge extensions to prevent sagging that could result in interference between longitudinal edge extensions of said adjacent panels when said panels are substantially in the horizontal position.

2. A sectional door according to claim 1, wherein said up-bow is distributed along the entirety of the longitudinal edge extensions of said panels between said ends thereof.

3. A sectional door according to claim 1, wherein said up-bow provides a maximum defection at substantially the longitudinal center of said longitudinal edge extensions.

4. A sectional door according to claim 3, wherein said maximum deflection is approximately 1/480 of the length of said panels.

5. A sectional door according to claim 3, wherein said maximum deflection is a measurement of the distance between a plane tangential to said center of said longitudinal edge extensions and the ends of said panel in a plane perpendicular to said plane tangential to said center of said longitudinal edge extensions.

6. A sectional door according to claim 3, wherein each of said longitudinal edge extensions of said panels have substantially the same maximum deflection.

7. A sectional door according to claim 3, wherein said longitudinal edge extensions of said panels have a differing maximum deflection.

8. A sectional door according to claim 1, wherein said panels have end stiles located at said ends for enhancing the rigidity of said panels.

9. A sectional door according to claim 8, wherein said panels have a center stile located at substantially the longitudinal center of said panels.

10. A sectional door according to claim 1, wherein said longitudinal edge extensions of said panels include a generally concave configuration at one of said edge extensions and a generally convex configuration at the other of said edge extensions.

11. A sectional door according to claim 10, wherein said longitudinal edge extensions terminate in reinforcing lips extending the length of said panels.

12. A sectional door panel for a sectional door system comprising, a generally rectangular facer defining the perimeter of the panel, longitudinal edges extending the length of said facer, ends of said facer at the termination of said longitudinal edges, said longitudinal edges having projecting extensions extending away from said facer, and an out-bow in said facer and longitudinal edges extending in a direction opposite said projecting extensions of said longitudinal edges, whereby said out-bow assists in preventing distortion of the panel when positioned in certain orientations.

13. A sectional door panel according to claim 12, wherein said out-bow is distributed along the entirety of said facer between said ends thereof.

14. A sectional door panel according to claim 12, wherein said out-bow provides a maximum deflection at substantially the longitudinal center of said longitudinal edges.

15. A sectional door panel according to claim 14, wherein said maximum deflection is approximately 1/480 of the length of said facer.

16. A sectional door panel according to claim 14, wherein said longitudinal edges of said facers have substantially the same maximum deflection.

17. A sectional door panel according to claim 12, wherein end stiles are located at said ends for enhancing the rigidity of said facers.

18. A sectional door panel according to claim 17, wherein a center stile is located at substantially the longitudinal center of said facer.

19. A sectional door panel according to claim 12, wherein one of said projecting extensions is generally concave and the other of said projecting extensions is generally convex.
